(19) United States
(12) Patent Application Publication
(10) Pub. No.: US 2008/0046771 A1
(43) Pub. Date: Feb. 21, 2008

(54) ADJUSTABLE DELAY COMPENSATION CIRCUIT

(76) Inventor: Chi-Chun Hsu, Taipei County (TW)

Correspondence Address: NORTH AMERICA INTELLECTUAL PROPERTY CORPORATION, P.O. BOX 506, MERRIFIELD, VA, 22116, US

(21) Appl. No.: 11/465,115

(22) Filed: Aug. 16, 2006

(51) Int. Cl. G06F 1/12

(52) U.S. Cl. 713/401

(57) ABSTRACT

A data transmitting end utilizes a clock signal to transmit at least a data signal to a data receiving end. An adjustable delay compensation circuit for compensating data transmission delay between the data transmitting end and the data receiving end includes an adjustable delay circuit, a clock gating circuit, and at least a target signal generating circuit. The adjustable delay circuit is used for delaying the clock signal by a programmable delay amount to generate a target delay signal. The clock gating circuit is used for allowing the clock signal to reach the adjustable delay circuit when receiving a data transmission enabling signal. The target signal generating circuit is used for receiving the data signal and for sampling the data signal according to the target delay signal.

### BACKGROUND OF THE INVENTION

The present invention relates to a delay compensation circuit, and more particularly, relates to an adjustable compensation circuit.

In order to reduce the cost of an optical disc drive, the number of pads is typically decreased, such that a serial flash interface replaces the parallel flash interface with a large number of pads. Since the data throughput of the processor in the optical disc increases, the speed of the serial flash is also required to increase. However, since there is a large delay when passing data through a transmission line and the pads, as the speed of the serial flash increases, the delay from chip A to chip B may be larger than the operation period. It causes that the chip communication is not work. Thus, a delay compensation delay is needed to compensate the delay of clock and data.

FIG. 1 is a block diagram illustrating a related art compensation circuit 100. As shown in FIG. 1, a latch 101 is used for latching input data Dᵢₙ. The latched input data LDᵢₙ is selected by the multiplexer 103 to be the target data TD when a delay of the input data Dᵢₙ is over half of the data clock, and the input data Dᵢₙ is selected by the multiplexer 103 to be the target data TD when the delay of the input data Dᵢₙ is less than half of the data clock. Afterwards, the target data TDᵢₙ is inputted to the flip-flop 105, and is sampled by the data transmission clock CLK to generate output data OD.

However, in this circuit the turn-on/turn-off of the latch 101 is determined according to the data transmission clock CLK. Accordingly, the operation the latch 101 becomes complicated if the transmission clock CLK varies frequency. Moreover, the determination of the threshold frequency according to which the latch 101 is turned on or turned off is also an important issue to be considered. Additionally, varying the transmission clock for this circuit is also complicated. That is, when the transmission clock is required to change, the clock is first changed to a transitional frequency at which the latch 101 can function smoothly, and then the clock is changed to the target frequency. Such steps decrease the overall speed of the circuit.

FIG. 2 is a block diagram illustrating a related art compensation circuit 200. The circuit 200 utilizes a delayed enable signal to control latched input data. As shown in FIG. 2, the enable signal En is delayed by the delay line 201, the delay line 202, and the delay line 203 to generate delay signals DEₙ₁, DEₙ₂, and DEₙ₃, respectively. Then, one of the delay signals DEₙ₁, DEₙ₂, and DEₙ₃ is selected by the multiplexer 205 to be the target delay signal TDEₙ to enable the latch 207.

Normally, the method for generating the enable signal En involves utilizing a control logic circuit to generate an initial enable signal, and performing an “AND” operation to the initial enable signal and a data transmission signal to generate the enable signal. In this way, the enable signal is prevented from glitching. However, such a method is a synchronized method, and thus STA (Static Timing Analyzer) tool cannot check the timing easily, and it requires a manual checking step to check if the circuit can function properly during the IC design flow. Therefore, the IC design flow becomes further complicated. Also, the latch 207 causes the delay margin to be limited to ½ T.

Thus, an invention is needed to solve these problems.

### SUMMARY OF THE INVENTION

Thus, one objective of the present invention is providing a delay compensation circuit utilizing a clock gating circuit and at least one register to synchronize a data signal and data transmission clock signals.

According to the claimed invention, an adjustable delay compensation circuit for compensating data transmission delay between a data transmitting end and a data receiving end is disclosed, wherein the data transmitting end utilizing a clock signal to transmit at least a data signal to the data receiving end. The adjustable delay circuit comprises: an adjustable delay circuit, a clock gating circuit, and at least a target signal generating circuit. The adjustable delay circuit, which is coupled to the clock signal, is used for delaying the clock signal by a programmable delay amount to generate a target delay signal. The clock gating circuit, which is coupled to the adjustable delay circuit, is used for allowing the clock signal to reach the adjustable delay circuit when receiving a data transmission enabling signal. The target signal generating circuit, which is coupled to the adjustable delay circuit, is used for receiving the data signal and for sampling the data signal according to the target delay signal.

According to the claimed invention, a delay compensation method for compensating data transmission delay between a data transmitting end and a data receiving end is also disclosed, wherein the data transmitting end utilizing a clock signal to transmit at least a data signal to the data receiving end. The delay compensation method comprises: (a) giv a target pattern; (b) delaying the clock signal by a programmable delay amount to generate a target delay signal; (c) checking if the circuit function meet the target pattern, if yes, go to step (e), else go to step (d); (d) delaying the clock by another programmable delay amount to generate a target delay signal and jump to step (c); (e) sampling the data signal according to the target delay signal.

According to the claimed invention, a method for determining the delay amount of a delay compensation circuit for data transmission between a data transmitting end and a data receiving end is also disclosed. The method comprises: calculating or setting the period of the highest speed signal transmitted between the data transmitting end and the data receiving end B, the minimum delay of the signal transmitting between the data transmitting end and the data receiving end A1, and the maximum delay of the signal transmitting between the data transmitting end and the data receiving end A2; and setting the delay amount of the adjustable delay circuit to meet the following rules: max{(A1−B), 0}<Dₘᵢₙ<A1 and (A2−B)<Dₘₐₓ<min{A2, B}, where Dₘᵢₙ indicates the minimum delay of the adjustable delay circuit, Dₘₐₓ indicates the maximum delay of the adjustable delay circuit.

According to the claimed invention, another method for determining the delay amount of a delay compensation circuit for data transmission between multi data transmitting end and a data receiving end is also disclosed. The method comprises: calculating or setting the period of the highest speed signal transmitted between the data transmitting end and the data receiving end B, the minimum delay of the signals transmitting between the data transmitting end and the data receiving end (A1_1 A1_2 . . . A1_N), and the maximum delay of the signal transmitting between the data transmitting end and the data receiving end (A2_1, A2_2 . . . A2_N); and setting the delay amount of the adjustable delay circuit to meet the following rules: max{(max [A1_1, A1_2, . . . , A1_N]−B), 0}<Dₘᵢₙ<min {min[A1_1, A1_2, . . . , A1_N]} and (max[A2_1, A2_2, . . . , A2_N]−B)<Dₘₐₓ<min {min[A2_1, A2_2, . . . , A2_N], B}, where Dₘᵢₙ indicates the minimum delay of the adjustable delay circuit, Dₘₐₓ indicates the maximum delay of the adjustable delay circuit.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram illustrating a related art delay compensation circuit.

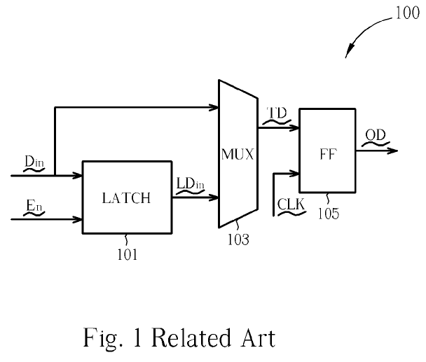

FIG. 2 is a block diagram illustrating another related art delay compensation circuit.

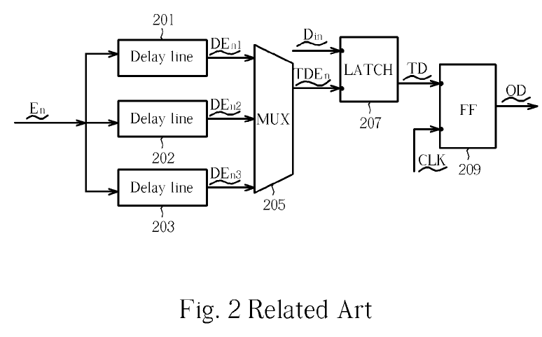

FIG. 3 is a diagram illustrating a location of an adjustable delay compensation circuit according to a first embodiment of the present invention.

FIG. 4 is a block diagram illustrating the adjustable delay compensation circuit according to the first embodiment of the present invention.

FIG. 5 is a diagram illustrating a location of an adjustable delay compensation circuit according to a second embodiment of the present invention.

FIG. 6 is a block diagram illustrating the adjustable delay compensation circuit according to the second embodiment of the present invention.

FIG. 7 is a flow chart illustrating a delay compensation method for compensating data transmission delay between a data transmitting end and a data receiving end corresponding to the adjustable delay compensation circuit shown in FIG. 4 and FIG. 6.

### DETAILED DESCRIPTION

Certain terms are used throughout the description and following claims to refer to particular components. As one skilled in the art will appreciate, electronic equipment manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

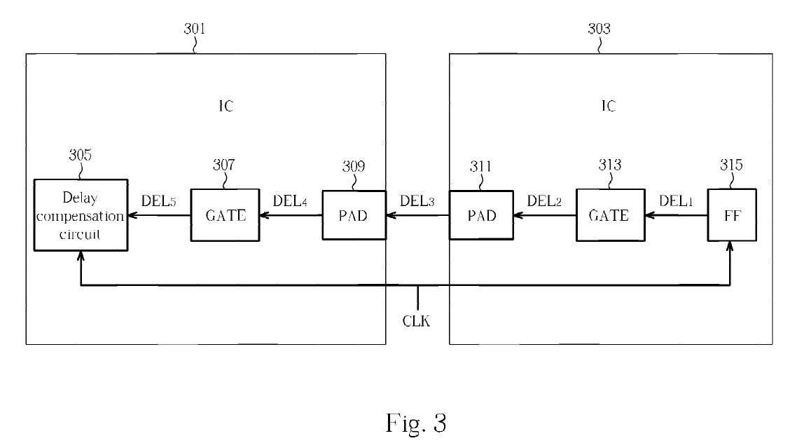

FIG. 3 is a diagram illustrating a location of an adjustable delay circuit according to a first embodiment of the present invention. As shown in FIG. 3, IC 301 includes a gate 307 and a pad 309; and IC 303 also includes a pad 311, a gate 313 and a flip-flop 315. When data is transmitted from IC 303 to IC 301, the data includes different kinds of delay: DEL1 between flip-flop 315 and gate 313, DEL2 between pad 311 and gate 313, DEL3 between pad 309 and pad 311, DEL4 between gate 307 and pad 309, and DEL 5 between gate 307 and delay compensation circuit 305 according the first embodiment of the present invention. The compensation circuit 305 is used to provide delay corresponding to the transmitting data to the data transmission clock CLK.

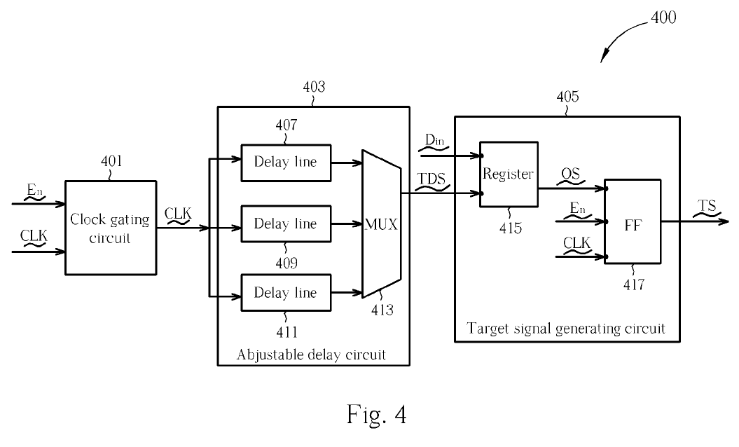

FIG. 4 is a block diagram illustrating the adjustable delay compensation circuit 400 according to the first embodiment of the present invention. It should be noted that although, according to this embodiment, the adjustable delay compensation circuit is utilized for the data transmission between the two ICs, the adjustable delay compensation circuit could instead be utilized for other data transmission requirements between a transmitting end and a receiving end.

As shown in FIG. 4, the adjustable delay compensation circuit 400 includes a clock gating circuit 401, an adjustable delay circuit 403, a target signal generating circuit 405. The clock gating circuit 401 is used for allowing the clock signal CLK to reach the adjustable delay circuit 403 when receiving a data transmission enabling signal Eₙ. As is well known, if the clock gating circuit 401 is not enabled, the data transmission clock CLK cannot pass the clock gating circuit 401, thus the adjustable delay compensation circuit 400 does not operate.

The adjustable delay circuit 403 is used for delaying the data transmission clock signal CLK by a programmable delay amount to generate a target delay signal TDS. The target signal generating circuit 405 is used for receiving the data signal Dᵢₙ and for sampling the data signal Dᵢₙ according to the target delay signal TDS.

In this embodiment, if the programmable delay amount of the adjustable delay circuit 403 meets Equation (1), the adjustable delay compensation circuit 400 is suitable for a data transmission clock signal CLK with any frequency.

max{(A1−B),0}<Dₘᵢₙ<A1 and (A2−B)<Dₘₐₓ<min{A2,B} Equation (1)

Dₘᵢₙ indicates the minimum delay of the adjustable delay circuit 403, Dₘₐₓ indicates the maximum delay of the adjustable delay circuit 403, B indicates the period of the highest speed data signal transmitted between the data transmitting end and the data receiving end, A1 indicates the minimum delay of the data signal transmitting between the data transmitting end and the data receiving end, and A2 indicates the maximum delay of the data signal transmitting between the data transmitting end and the data receiving end.

In this embodiment, the adjustable delay circuit includes a plurality of delay lines 407, 409 and 411, and a multiplexer (MUX) 413. The delay lines 407, 409 and 411 are used for delaying the data transmission clock signal CLK to generate a plurality of delay signals, respectively, where each delay is programmed with an arbitrary delay amount meeting the rules shown in equation (1). The multiplexer (MUX) is used for choosing one of the delay signals from the delay lines 407, 409 and 411 as the target delay signal TDS.

Also, in this embodiment, the target signal generating circuit 405 includes a register 415 and a flip-flop 417. The register 415 receives the data signal Dᵢₙ and utilizes the target delay signal TDS to sample the data signal Dᵢₙ to generate the output signal OS from the register 415 to generate a target signal TS.

According to the cooperation of the clock gating circuit 401 and the register 415, the delay margin increases from ½ T to T, wherein T indicates the period of the data transmission clock CLK. Also, since the clock gating circuit 401 is used, STA can automatically check the timing of the clock gating circuit 401. Furthermore, since the input of the adjustable delay compensation circuit 400 is the data transmission clock CLK, the timing of the adjustable delay compensation circuit 400 can be checked by an automatic IC design mechanism.

According to the first embodiment of the present invention, the register 405 can be a flip-flop or a latch. If the register 405 is a flip-flop, the delay margin of the delay compensation circuit 400 is T. If the register 405 is a latch, the compensation circuit 400 still works, but the delay margin decreases to ½ T, because the sampling rule of the flip-flop and the latch is different.

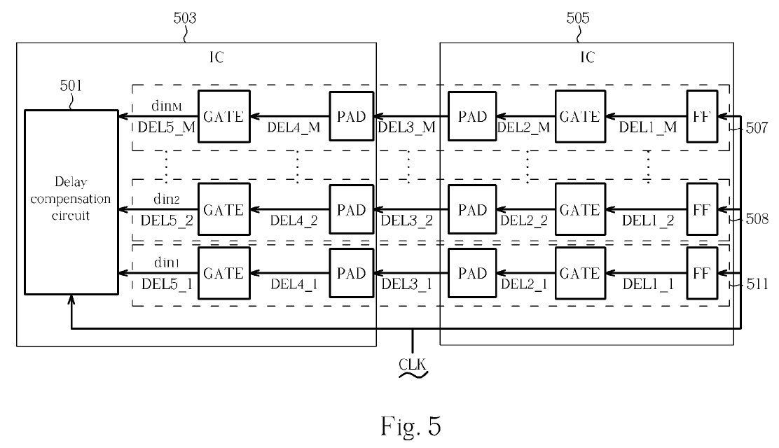

FIG. 5 is a diagram illustrating a location of an adjustable delay compensation circuit according to a second embodiment of the present invention. In this embodiment, the adjustable delay circuit 501 according to the present invention is applied to ICs with a plurality of data channels.

As shown in FIG. 5, there are several data channels 507, 509 and 511 between ICs 503 and 505. Each data channel includes flip-flop, gates and pads, and the data transmitting from IC 503 to IC 505 includes various kinds of delay (DEL 1-1 . . . DEL3-2 . . . DEL 5-M). The adjustable delay circuit 501 is used for compensating these delays, respectively. It should be noted that although, according to this embodiment, the adjustable delay compensation circuit according to the present invention is utilized for the data transmission between the two ICs, the adjustable delay compensation circuit can also be utilized for other data transmission requirements between a transmitting end and a receiving end.

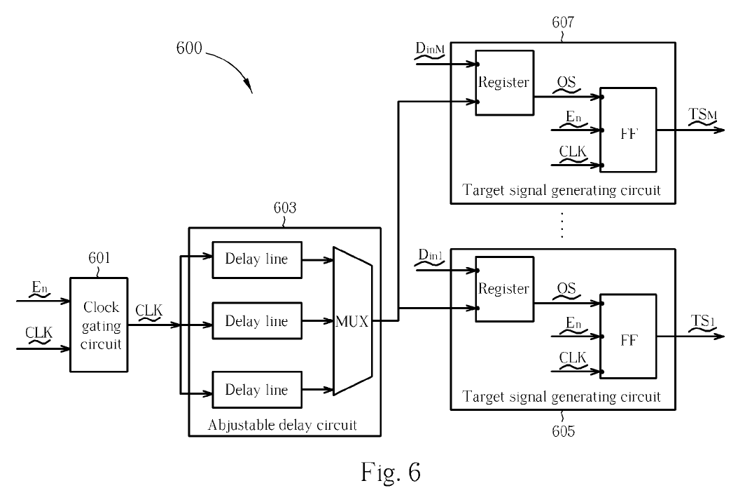

FIG. 6 is a block diagram illustrating the adjustable delay compensation circuit 600 according to the second embodiment of the present invention. As shown in FIG. 6, the adjustable delay compensation circuit 600 also includes a clock gating circuit 601 and an adjustable delay circuit 603. The only difference between the adjustable delay compensation circuit 400 and the adjustable delay compensation circuit 600 is that the adjustable delay compensation circuit 600 includes more than one target signal generating circuit 605, 607 . . . (some of which are not shown). The number of the target signal generating circuits 605, 607 . . . corresponds to the number of data channels 507˜511 shown in FIG. 5, and the target signal generating circuits 605, 607 . . . receive the data signals Dᵢₙ₁˜Dᵢₙₘ from the data channels 507˜511, respectively. According to this structure, the delay of the data signals from different channels can be compensated. The operation of the devices shown in FIG. 6 is similar to that shown in FIG. 4 and thus a repeated description is omitted herein for brevity.

In this embodiment, the delay amount of the adjustable delay circuit 603 meets the rules of equation (2):

max{(max [A1_{—}1,A1_{—}2, . . . ,A1_{—}N]−B),0}<Dₘᵢₙ<min {min[A1_{—}1,A1_{—}2, . . . ,A1_{—}N]} and (max[A2_{—}1,A2_{—}2, . . . ,A2_{—}N]−B)<Dₘₐₓ<min {min[A2_{—}1, A2_{—}2, . . . ,A2_{—}N],B} Equation (2)

Dₘᵢₙ indicates the minimum delay of the adjustable delay circuit, Dₘₐₓ indicates the maximum delay of the adjustable delay circuit, B indicates the period of the highest speed data signal transmitted between the data transmitting end and the data receiving end, (A1_1, A1_2 . . . A1_N) respectively indicate the minimum delay of the data signals transmitting between the data transmitting end and the data receiving end, and (A2_1, A2_2 . . . A2_N) respectively indicate the maximum delay of the data signals transmitting between the data transmitting end and the data receiving end.

Also, according to the second embodiment of the present invention, the register 405 can be a flip-flop or a latch. If the register 405 is a flip-flop, the delay margin of the delay compensation circuit 400 is T. If the register 405 is a latch, the compensation circuit 400 still functions, but the delay margin decreases to ½ T, because the sampling rule of the flip-flop and the latch is different.

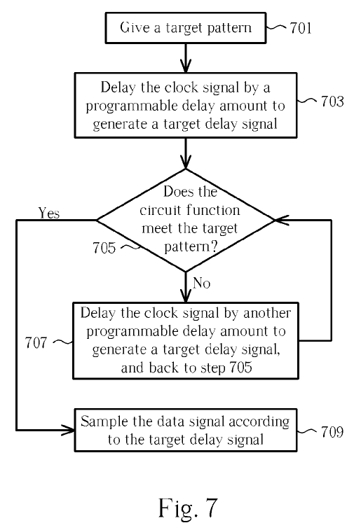

FIG. 7 is a flowchart illustrating a delay compensation method for compensating data transmission delay between a data transmitting end and a data receiving end corresponding to the adjustable delay compensation circuit shown in FIG. 4 and FIG. 6. As shown in FIG. 7, the method includes the following steps:

Step 701:

Give a target pattern.

The target pattern can be a fixed data sequence or a system function such as (01010110) data sequence or servo on an optical system, but it doesn't mean to limit the present invention.

Step 703:

Delay the clock signal by a programmable delay amount to generate a target delay signal.

Step 705:

Check if the circuit function meet the target pattern, if yes, go to step 709, else go to step 707.

Step 707:

Delay the clock signal by another programmable delay amount to generate a target delay signal, and back to step 705

### Step 709:

Sample the data signal according to the target delay signal.

According to equation (1), a method for determining the delay amount of a delay compensation circuit for data transmission between a data transmitting end and a data receiving end is obtained. The method comprises calculating or setting the period of the highest speed signal transmitted between the data transmitting end and the data receiving end B, the minimum delay of the signal transmitting between the data transmitting end and the data receiving end A1, and the maximum delay of the signal transmitting between the data transmitting end and the data receiving end A2. The method then sets the delay amount of the adjustable delay circuit to meet the rules shown in equation (1). As the delay amount of the adjustable delay circuit meets equation (1), the clock signal inputted to the adjustable delay circuit can have any frequency.

Additionally, according to equation (2), a method for determining the delay amount of a delay compensation circuit for data transmission between a data transmitting end and a data receiving end is obtained. The method comprises calculating or setting the period of the highest speed signal transmitted between the data transmitting end and the data receiving end B, the minimum delay of the signals transmitting between the data transmitting end and the data receiving end (A1_1, A1_2 . . . A1_N), and the maximum delay of the signal transmitting between the data transmitting end and the data receiving end (A2_1, A2_2 . . . A2_N). The method then sets the delay amount of the adjustable delay circuit to meet the rules shown in equation (2). As the delay amount of the adjustable delay circuit meets equation (2), the clock signal inputted to the adjustable delay circuit can have any frequency.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An adjustable delay compensation circuit for compensating data transmission delay between a data transmitting end and a data receiving end, the data transmitting end utilizing a clock signal to transmit at least a data signal to the data receiving end, the adjustable delay circuit comprising:
an adjustable delay circuit, coupled to the clock signal, for delaying the clock signal by a programmable delay amount to generate a target delay signal;
a clock gating circuit, coupled to the adjustable delay circuit, for allowing the clock signal to reach the adjustable delay circuit when receiving a data transmission enabling signal; and
at least a target signal generating circuit, coupled to the adjustable delay circuit, for receiving the data signal and for sampling the data signal according to the target delay signal.

2. The adjustable delay circuit of claim 1, wherein the adjustable delay circuit comprises:
a plurality of delay lines, for delaying the clock signal to generate a plurality of delay signals, respectively; and
a multiplexer (MUX), coupled to the delay lines, for choosing one of the delay signals as the target delay signal.

3. The adjustable delay circuit of claim 1, wherein each of the target signal generating circuits comprises:
a register, for sampling the data signal by utilizing the target delay signal to generate an output signal; and
a flip flop, coupled to the register, for sampling the output signal according to the clock signal.

4. The adjustable delay circuit of claim 3, wherein the register is a flip-flop or a latch.

5. The adjustable delay circuit of claim 1, wherein the programmable delay amount of the adjustable delay circuit meets a set of predetermined rules: max{(A1−B), 0}<Dₘᵢₙ<A1 and (A2−B)<Dₘₐₓ<min{A2, B}, where Dₘᵢₙ indicates the minimum delay of the adjustable delay circuit, Dₘₐₓ indicates the maximum delay of the adjustable delay circuit, B indicates the period of the highest speed data signal transmitted between the data transmitting end and the data receiving end, A1 indicates the minimum delay of the data signal transmitting between the data transmitting end and the data receiving end, and A2 indicates the maximum delay of the data signal transmitting between the data transmitting end and the data receiving end.

6. The adjustable delay circuit of claim 5, wherein the adjustable delay circuit comprises:
a plurality of delay lines, for delaying the clock signal to generate a plurality of delay signals, respectively, wherein each delay is programmed with an arbitrary delay amount meeting the set of predetermined rules; and
a multiplexer (MUX), coupled to the delay lines, for choosing one of the delay signals as the target delay signal.

7. The adjustable delay circuit of claim 5, wherein each of the target signal generating circuits comprises:
a register, for sampling the data signal by utilizing the target delay signal to generate an output signal; and
a flip flop, coupled to the register, for sampling the output signal according to the clock signal.

8. The adjustable delay circuit of claim 7, wherein the register is a flip-flop or a latch.

9. The adjustable delay circuit of claim 1, wherein the adjustable delay circuit includes a plurality of target signal generating circuits, the number of the target signal generating circuits is equal to the number of data channels between the data transmitting end and the data receiving end, and the data channels transmit a plurality of data signals, respectively.

10. The adjustable delay circuit of claim 9, wherein the programmable delay amount of the adjustable delay circuit meets a set of predetermined rules: max{(max [A1_1, A1_2, . . . , A1_N]−B), 0}<Dₘᵢₙ<min {min[A1_1, A1_2, . . . , A1_N]} and (max[A2_1, A2_2, . . . , A2_N]−B)<Dₘₐₓ<min {min[A2_1, A2_2, . . . , A2_N], B}, where Dₘᵢₙ indicates the minimum delay of the adjustable delay circuit, Dₘₐₓ indicates the maximum delay of the adjustable delay circuit, B indicates the period of the highest speed data signal transmitted between the data transmitting end and the data receiving end, (A1_1, A1_2 . . . A1_N) respectively indicate the minimum delay of the data signals transmitting between the data transmitting end and the data receiving end, and (A2_1, A2_2 . . . A2_N) respectively indicate the maximum delay of the data signals transmitting between the data transmitting end and the data receiving end.

11. The adjustable delay circuit of claim 9, wherein the adjustable delay circuit comprises:
a plurality of delay lines, for delaying the clock signal to generate a plurality of delay signals, respectively, wherein each delay is programmed with an arbitrary delay amount meeting the set of predetermined rules; and
a multiplexer (MUX), coupled to the delay lines, for choosing one of the delay signals as the target delay signal.

12. The adjustable delay circuit of claim 9, wherein each of the target signal generating circuits comprises:
a register, for sampling the data signal by utilizing the target delay signal to generate an output signal; and
a flip flop, coupled to the register, for sampling the output signal according to the clock signal.

13. The adjustable delay circuit of claim 12, wherein the register is a flip-flop or a latch.

14. A delay compensation method for compensating data transmission delay between a data transmitting end and a data receiving end, the data transmitting end utilizing a clock signal to transmit at least a data signal to the data receiving end, the delay compensation method comprising:
(a) giving a target pattern;
(b) delaying the clock signal by a programmable delay amount to generate a target delay signal;
(c) checking if the circuit function meets the target pattern, if yes, go to to step (e), else go to step (d);
(d) delaying the clock by another programmable delay amount to generate a target delay signal and jump to step (c);
(e) sampling the data signal according to the target delay signal.

15. The delay compensation method of claim 14, wherein the step (b) or (d) comprises:
delaying the clock signal to generate a plurality of delay signals, respectively; and
choosing one of the delay signals as the target delay signal.

16. The delay compensation method of claim 14, wherein the step (e) comprises:
(f) sampling the data signal by utilizing the target delay signal to generate an output signal; and
(g) sampling the output signal according to the clock signal.

17. The delay compensation method of claim 16, wherein the step (f) is performed by a flip-flop or a latch.

18. The delay compensation method of claim 14, wherein the programmable delay amount of the meets a set of predetermined rules: max{(A1−B), 0}<Dₘᵢₙ<A1 and (A2−B)<Dₘₐₓ<min{A2, B}, where Dₘᵢₙ indicates the minimum delay of an adjustable delay circuit, Dₘₐₓ indicates the maximum delay of the adjustable delay circuit, B indicates the period of the highest speed data signal transmitted between the data transmitting end and the data receiving end, A1 indicates the minimum delay of the data signal transmitting between the data transmitting end and the data receiving end, and A2 indicates the maximum delay of the data signal transmitting between the data transmitting end and the data receiving end.

19. The delay compensation method of claim 18, wherein the step (b) or (d) comprises:
delaying the clock signal to generate a plurality of delay signals, respectively; and
choosing one of the delay signals as the target delay signal.

20. The delay compensation method of claim 18, wherein the step (e) comprises:
(f) sampling the data signal by utilizing the target delay signal to generate an output signal; and
(g) sampling the output signal according to the clock signal.

21. The delay compensation method of claim 20, wherein the step (f) is performed by a flip-flop or a latch.

22. The delay compensation method of claim 14, wherein the step (e) is performed by a plurality of target signal generating circuits, the number of the target signal generating circuits is equal to the number of data channels between the data transmitting end and the data receiving end, and the data channels transmit a plurality of data signals, respectively.

23. The delay compensation method of claim 22, wherein the programmable delay amount of an adjustable delay circuit meets a set of predetermined rules: max{(max [A1_1, A1_2, . . . , A1_N]−B), 0}<Dmin<min {min[A1_1, A1_2, . . . , A1_N]} and (max[A2_1, A2_2, . . . , A2_N]−B)<Dmax<min {min[A2_1, A2_2, . . . , A2_N], B}, where Dmin indicates the minimum delay of the adjustable delay circuit, Dmax indicates the maximum delay of the adjustable delay circuit, B indicates the period of the highest speed data signal transmitted between the data transmitting end and the data receiving end, (A1_1, A1_2 . . . A1_N) respectively indicate the minimum delay of the data signals transmitting between the data transmitting end and the data receiving end, and (A2_1, A2_2 . . . A2_N) respectively indicate the maximum delay of the data signals transmitting between the data transmitting end and the data receiving end.

24. The delay compensation method of claim 22, wherein the step (b) or (d) comprises:
delaying the clock signal to generate a plurality of delay signals, respectively; and
choosing one of the delay signals as the target delay signal.

25. The delay compensation method of claim 22, wherein the step (e) comprises:
(f) sampling the data signal by utilizing the target delay signal to generate an output signal; and
(g) sampling the output signal according to the clock signal.

26. The delay compensation method of claim 25, wherein the step (f) is performed by a flip-flop or a latch.

27. The delay compensation method of claim 14, wherein the target pattern is a fixed data sequence or a system function.

28. A method for determining the delay amount of a delay compensation circuit for data transmission between a data transmitting end and a data receiving end, the method comprising:
calculating or setting the period of the highest speed signal transmitted between the data transmitting end and the data receiving end B, the minimum delay of the signal transmitting between the data transmitting end and the data receiving end A1, and the maximum delay of the signal transmitting between the data transmitting end and the data receiving end A2; and
setting the delay amount of an adjustable delay circuit to meet the following rules:
max{(A1−B), 0}<Dₘᵢₙ<min A1 and (A2−B)<Dₘₐₓ<min{A2, B}, where Dₘᵢₙ indicates the minimum delay of the adjustable delay circuit, Dₘₐₓ indicates the maximum delay of the adjustable delay circuit.

29. A method for determining the delay amount of a delay compensation circuit for data transmission between a data transmitting end and a data receiving end, the method comprising:
calculating or setting the period of the highest speed signal transmitted between the data transmitting end and the data receiving end B, the minimum delay of the signals transmitting between the data transmitting end and the data receiving end (A1_1, A1_2 . . . A1_N), and the maximum delay of the signal transmitting between the data transmitting end and the data receiving end (A2_1, A2_2 . . . A2 . . . N ); and
setting the delay amount of the adjustable delay circuit to meet the following rules:
max{(max [A1_1, A1_2, . . . , A1_N]−B), 0}<Dₘᵢₙ<min {min[A1_1, A1_2, . . . , A1_N]} and (max[A2_1, A2_2, . . . , A2_N]−B)<Dₘₐₓ<min {min[A2_1, A2_2, . . . , A2_N], B}, where Dₘᵢₙ indicates the minimum delay of the adjustable delay circuit, Dₘₐₓ indicates the maximum delay of the adjustable delay circuit.
